(19) United States
(12) Patent Application Publication
(10) Pub. No.: US 2025/0100865 A1
(43) Pub. Date: Mar. 27, 2025

(54) Keg Tap or Nozzle Sanitary Cover Device

(71) Applicant: Paul Schutte, Akron, OH (US)

(72) Inventor: Paul Schutte, Akron, OH (US)

(21) Appl. No.: 18/790,139

(22) Filed: Jul. 31, 2024

Related U.S. Application Data
(60) Provisional application No. 63/584,954, filed on Sep. 25, 2023.

(51) Int. Cl. B67D 1/08

(52) U.S. Cl. CPC B67D 1/0887

(57) ABSTRACT

A beer keg tap or nozzle sanitation cover device comprising a food-grade silicone, rubber, or plastic cover is disclosed. The cover has a textured surface for easy handling and withstands temperatures from −10 to 30 degrees Celsius. An eyelet made of rust-free material is disposed on the top end of the cover and attaches a metal or plastic link chain or tether to the cover, preventing loss and contamination of the cover. The chain is adjustable in length and is secured to the keg faucet with a plastic wire tie. The cover may include a UV-C light for additional sanitization and can be manufactured via 3D printing or injection molding. The chain prevents the rubber or plastic cover from being misplaced or lost and prevents the cover from touching the keg base or stand when removed from the nozzle.

### CROSS-REFERENCE TO RELATED APPLICATION

The present application claims priority to, and the benefit of, U.S. Provisional Application No. 63/584,954, which was filed on Sep. 25, 2023 and is incorporated herein by reference in its entirety.

### FIELD OF THE INVENTION

The present invention generally relates to the field of keg devices. More specifically, the present invention relates to a novel beer keg tap or nozzle sanitation cover device. The device includes a rubber or plastic cover molded to fit a draft jerk tap/nozzle or keg tap/nozzle. The rubber or plastic cover is attached to a metal or plastic link chain via an eyelet. The chain is tied to the beer keg using a wire tie to prevent loss or contamination of the cover. The chain prevents the cover from being lost or dropped, reducing the chance of any contamination. Accordingly, the present disclosure makes specific reference thereto. Nonetheless, it is to be appreciated that aspects of the present invention are also equally applicable to other like applications, devices, and methods of manufacture.

### BACKGROUND

By way of background, many individuals use in homes and businesses utilize jerk-style keg dispenser taps or nozzles for dispensing beer and other beverages. However, commonly, flies, gnats, and other contaminants can enter the nozzle which contaminates the tap or nozzle. This poses hygiene concerns as the foreign elements can contaminate the beverage, leading to potential health risks.

Individuals often resort to rubber or plastic covers for covering such taps/nozzles. However, such rubber or plastic covers are difficult to handle and can accidentally drop during handling. The traditional rubber or plastic covers often come into contact with unsanitary surfaces when dropped rendering them unusable. The covers become unhygienic and necessitates frequent replacement of the covers, adding to the inconvenience and cost. Reinstalling the rubber or plastic cover after each beverage service can be cumbersome, especially in busy environments. The process of removing and reattaching the cover increases the likelihood of accidental drops, further exacerbating the problem of maintaining nozzle cleanliness. Operators may be required to periodically clean the taps/nozzles which is labor intensive and time consuming. Individuals desire an improved solution that not only protects the keg tap or nozzle from contaminants but also ensures that the protective cover remains sanitary, secure, and easy to handle.

Therefore, there exists a long felt need in the art for an improved keg tap/nozzle protection device. There is also a long felt need in the art for an improved keg tap/nozzle protection device that prevents the cover from being dropped or lost. Additionally, there is a long felt need in the art for a special beer keg tap or nozzle sanitation cover that has an attached metal or plastic link chain to secure the cover. Moreover, there is a long felt need in the art for a uniquely designed beer keg tap or nozzle sanitation cover that uses a molded rubber or plastic cover, a metal or plastic chain, and a wire tie to promote better hygiene in beer dispensing operations. Further, there is a long felt need in the art for a beer keg tap or nozzle sanitation cover that enables the cover to remain consistently near the nozzle for easy accessibility. Furthermore, there is a long felt need in the art for a keg tap/nozzle cover device that prevents the rubber or plastic cover from being misplaced or lost and ensures the cover does not touch the keg base or stand when removed from the nozzle. Finally, there is a long felt need in the art for a uniquely designed keg tap/nozzle cover device that not only protects the keg tap/nozzle from contaminants but also ensures that the protective cover remains sanitary, secure, and easy to handle.

The subject matter disclosed and claimed herein, in one embodiment thereof, comprises a beer keg tap or nozzle sanitation cover device. The device features a molded rubber or plastic cover configured to detachably fit over a beer keg tap or nozzle. The rubber or plastic cover has a closed top end and an open bottom end, the exterior surface of the cover forms a hollow cavity to snugly accommodate and wrap around the nozzle. An eyelet is disposed on the top end of the rubber or plastic cover and a metal or plastic link chain is attached to the eyelet. The chain is configured to secure the rubber or plastic cover to the beer keg. A wire tie secures the chain to the faucet of the keg, wherein the chain prevents the rubber or plastic cover from being misplaced or lost and ensures the cover does not touch the keg base or stand when removed from the nozzle. The chain provides easy accessibility of the cover for application to cover the tap/nozzle.

In this manner, the beer keg tap or nozzle sanitation cover device of the present invention accomplishes all of the forgoing objectives and provides users with a novel cover device that not only protects the keg tap/nozzle from contaminants but also ensures that the protective cover remains sanitary, secure, and easy to handle. The metal or plastic link chain prevents the cover from being dropped or lost, thus maintaining the hygiene and usability thereof. The cover can be easily removed from the chain to wash and sanitize at the end of the day for a longer shelf life.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a beer keg tap or nozzle sanitation cover device. The device comprises a molded rubber or plastic cover configured to fit over a beer keg tap or nozzle. The rubber or plastic cover has a closed top end and an open bottom end, the exterior surface of the cover forms a hollow cavity to snugly accommodate and wrap around the nozzle. The rubber or plastic cover has embedded antimicrobial agents. An eyelet is disposed on the top end of the rubber or plastic cover and a metal or plastic link chain is attached to the eyelet and is configured to secure the rubber or plastic cover to the beer keg. A wire tie secures the chain to the faucet of the keg, wherein the chain prevents the rubber or plastic cover from being misplaced or lost and ensures the cover does not touch the keg base or stand when removed from the nozzle.

In yet another embodiment, a beer keg tap or nozzle sanitation cover device is disclosed. The device includes a molded rubber or plastic cover made of food-grade silicone or rubber, configured to fit over a beer keg tap or nozzle, the cover having a closed top end and an open bottom end, with a textured exterior surface for improved grip and handling. An eyelet is disposed on the top end of the rubber or plastic cover, the eyelet being made from a rust-free and corrosion-resistant material. A metal or plastic link chain is attached to the eyelet, the chain having adjustable length links to secure the rubber or plastic cover to the beer keg. A wire tie secures the chain to the faucet of the keg, the wire tie being made of plastic and available in various colors. The rubber or plastic cover can withstand a temperature range from −10 degrees Celsius to 30 degrees Celsius.

In another embodiment, a small, low-power UV-C light is integrated into the top end of the rubber or plastic cover for sanitizing the nozzle when the cover is in place. The rubber or plastic cover is made using 3D printing or injection molding and can be translucent or transparent for visual inspection of the nozzle without removing the cover.

In another aspect, the length of the rubber or plastic cover extends between about 2 inches to about 6 inches to accommodate different nozzle sizes.

In yet another aspect, the textured exterior surface of the rubber or plastic cover is designed for improved grip to facilitate easy installation and removal of the cover.

In still another embodiment, the rubber or plastic cover is positioned at approximately 2 inches above the keg, tap stand, or bar counter when not in use, to maintain hygiene and prevent contact with contaminants

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an isolated view of the beer keg tap or nozzle sanitation cover device of the present invention in accordance with the disclosed structure;

FIG. 2 illustrates a perspective view showing the beer keg tap or nozzle sanitation cover device of the present invention installed on a beer keg for covering a beer keg tap or nozzle in accordance with the disclosed structure; and

FIG. 3 illustrates a perspective view showing the rubber or plastic cover in an unfastened state in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an improved keg tap/nozzle protection device. There is also a long felt need in the art for an improved keg tap/nozzle protection device that prevents the cover from being dropped or lost. Additionally, there is a long felt need in the art for a special beer keg tap or nozzle sanitation cover that has an attached metal or plastic link chain to secure the cover. Moreover, there is a long felt need in the art for a uniquely designed beer keg tap or nozzle sanitation cover that uses a molded rubber or plastic cover, a metal or plastic chain, and a wire tie to promote better hygiene in beer dispensing operations. Further, there is a long felt need in the art for a beer keg tap or nozzle sanitation cover that enables cover to remain consistently near the nozzle for easy accessibility. Furthermore, there is a long felt need in the art for a keg tap/nozzle cover device that prevents the rubber or plastic cover from being misplaced or lost and ensures the cover does not touch the keg base or stand when removed from the nozzle. Finally, there is a long felt need in the art for a uniquely designed keg tap/nozzle cover device that not only protects the keg tap/nozzle from contaminants but also ensures that the protective cover remains sanitary, secure, and easy to handle.

The present invention, in one exemplary embodiment, is a keg tap/nozzle cover device. The device includes a rubber or plastic cover configured to fit over a beer keg tap or nozzle, the cover having a closed top end and an open bottom end, with a textured exterior surface for improved grip and handling. A circular eyelet is disposed on the top end of the rubber or plastic cover. A metal or plastic link chain is attached to the eyelet, the chain having adjustable length links to secure the rubber or plastic cover to the beer keg. A wire tie secures the chain to the faucet of the keg, the wire tie being made of plastic and available in various colors.

Reference will now be made in detail to the present preferred embodiments of the invention, examples of which are illustrated in the accompanying drawings. Wherever possible, the same reference numerals are used in the drawings and the description to refer to the same or like parts.

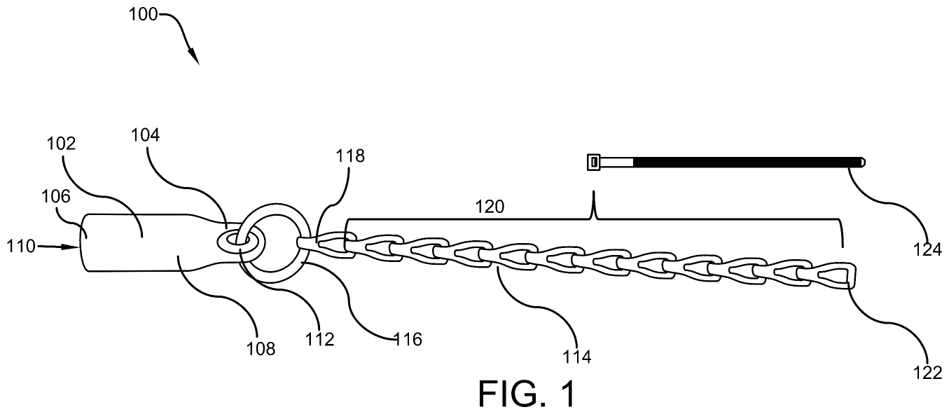

Referring initially to the drawings, FIG. 1 illustrates an isolated view of beer keg tap or nozzle sanitation cover device of the present invention in accordance with the disclosed structure. The beer keg tap or nozzle sanitation cover device 100 of the present invention is designed to cover a beer keg tap or nozzle to maintain the hygiene and cleanliness of the nozzle. More specifically, the cover device 100 is an aftermarket product that can be attached to the faucet of an existing keg. The sanitary cover system for beer keg taps or nozzles 100 can also be integrated to a keg during manufacturing of the keg. The cover device 100 includes a molded cover 102 which is generally elastic, flexible, and cylindrical. The cover 102 has a closed top end 104 and an open bottom end 106. The exterior surface 108 of the cover 102 forms a hollow cavity 110 in the cover 102 which is used for accommodating a beer keg tap or nozzle and snugly wrap around it to secure around the nozzle and protect the nozzle from contamination. The cover 102 can have a length extending between the top end 104 and the bottom end 106 in the range from about 2 inches to about 6 inches to cover different nozzles.

The cover 102 is embedded with antimicrobial agents to further enhance hygiene and prevent the growth of bacteria or mold. In the preferred embodiment, the cover 102 is made of food-grade silicone, plastic, or rubber. The cover 102 can withstand a wide range of temperatures, from cold storage conditions such as −10 degrees Celsius to warm dispensing environments such as 30 degrees Celsius. The outer surface 108 of the cover 102 is preferably textured for an improved grip for easy handling facilitating easy installation and removal of the cover 102. The cover 102 can be molded to fit the specific dimensions of a draft jerk tap or nozzle to provide a snug and secure fit.

An eyelet or loop 112 is disposed on the top end 104 of the cover 102 and is preferably in the form of a circular aperture. The eyelet or loop 112 is preferably made from a rust-free and corrosion-resistant material such as stainless steel or brass. The eyelet or loop 112 can have a diameter from about 0.1 inches to about 0.4 inches in different embodiments. The eyelet or loop 112 is adapted to provide a secure attachment of a link chain or tether 114 to the cover 102. The link chain or tether 114 is preferably made of a metal, steel, or plastic and is used for securing the cover 102 to the beer keg. The chain or tether 114 prevents the cover 102 from being misplaced or lost and enables the cover 102 to remain attached to the keg. A hook or ring 116 is looped to the eyelet or loop 112 and the first end 118 of the chain or tether 114 is secured to the hook or ring 116. The chain or tether 114 includes a plurality of links 120 wherein one or more links can be removed to adjust a length of the metal or plastic chain or tether 114. For securing the chain or tether 114 to a draft jerk or faucet hand of the keg, the second end 122 of the chain or tether 114 is secured using a wire tie or anchor 124. The wire tie or anchor 124 can be of any color and is preferably made of plastic.

The keg beer nozzle cover device 100 protects a nozzle from contaminants while preventing the cover 102 from being dropped and lost. The chain or tether 114 prevents the cover 102 from touching the keg or counter and therefore, maintains the usability and sanitization of the nozzle cover 102.

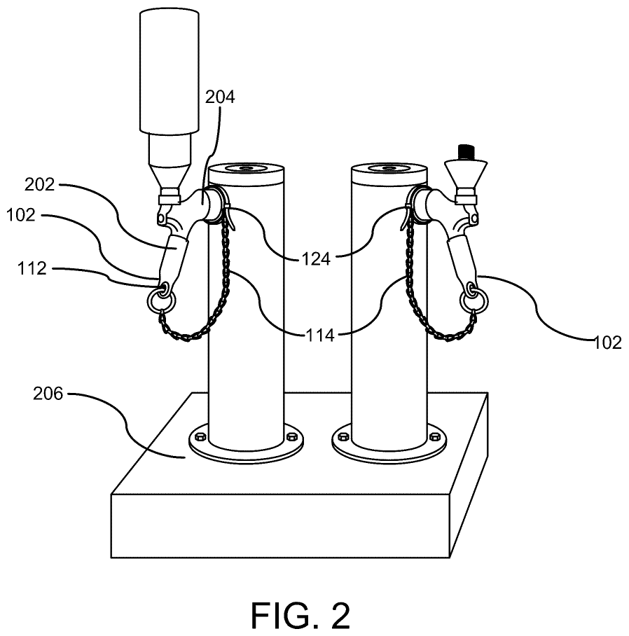

FIG. 2 illustrates a perspective view showing the beer keg tap or nozzle sanitation cover device of the present invention installed on a beer keg for covering a beer keg tap or nozzle in accordance with the disclosed structure. As illustrated, the cover 102 is secured around the nozzle 202 and the cover 102 is accommodated inside the cavity 110. The cover 102 is molded to size of the nozzle 202 and does not move or laterally displace without any unintentional disengagement. The cover 102 seals the nozzle 202 and eliminates any contact from pathogens, airborne particles, and more. The chain or tether 114 is secured to the faucet 204 using the wire tie or anchor 124 and length of the chain or tether 114 is adjusted such that when the cover 102 is removed from the nozzle 202 such as when nozzle 202 is required to dispense beer, the cover 102 does not touch the keg base or keg stand 206. This protects the cover 102 from becoming contaminated. The chain or tether 114 prevents the cover 102 from becoming lost and thus eliminates requirement of purchasing a plurality of rubber or plastic covers. The wire tie or anchor 124 protects the cover device 100 from becoming stolen or lost and prevents the chain from laterally displacing along the faucet 204.

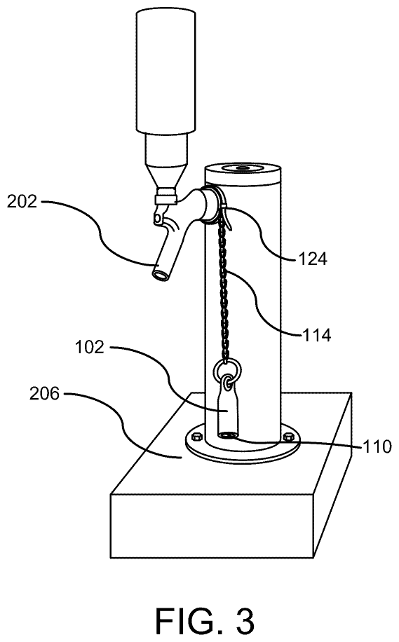

FIG. 3 illustrates a perspective view showing the rubber or plastic cover in an unfastened state in accordance with the disclosed structure. As illustrated, when the cover 102 is not secured around the nozzle 102 such as during use of the keg, the nozzle cover 102 remains tied to the chain or tether 114 and is positioned at about 2 inches above the keg base or stand. The secure connection of the chain or tether 114 and the cover 102 prevents the cover 102 from becoming lost and contaminated. Similarly, the chain or tether 114 is secured to the faucet, thereby preventing the device 100 from becoming lost or damaged.

In some embodiments, the top end 104 may include a small, low-power UV-C light inside the cover 102 that can sanitize the nozzle when the cover 102 is secured around the nozzle. Further, the cover 102 can be made using 3D printing or injection molding. In an embodiment, the cover 102 can be translucent or transparent to enable visual inspection of the nozzle without removing the cover 102.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “sanitary cover system for beer keg taps or nozzles”, “beer keg tap or nozzle sanitation cover device”, “cover device”, “beer keg tap or nozzle sanitary cover system”, and “device” are interchangeable and refer to the beer keg tap or nozzle sanitary cover device 100 of the present invention.

Notwithstanding the forgoing the beer keg tap or nozzle sanitary cover device 100 of the present invention can be of any suitable size and configuration as is known in the art without affecting the overall concept of the invention, provided that it accomplishes the above stated objectives. One of ordinary skill in the art will appreciate that the beer keg tap or nozzle sanitary cover device 100 as shown in the FIGS. are for illustrative purposes only, and that many other sizes and shapes of the beer keg tap or nozzle sanitary cover device 100 are well within the scope of the present disclosure. Although the dimensions the beer keg tap or nozzle sanitary cover device 100 are important design parameters for user convenience, the beer keg tap or nozzle sanitary cover device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A keg tap sanitation cover device comprising:
a nozzle cover;
a loop;
a ring;
a tether; and
an anchor;
wherein said nozzle cover having a closed top end and an open bottom end;
wherein said nozzle cover having a cylindrical wall between said closed top end and said open bottom end;
wherein said cylindrical wall having an exterior surface forming a cavity within said cylindrical wall for accommodating a keg nozzle;
wherein said loop integrated to said closed top end of said nozzle cover;
wherein said ring connecting said loop to one end of said tether;
wherein said tether having said anchor at another end of said tether;
wherein said anchor connecting said nozzle cover to a faucet of the keg tap; and
further wherein said nozzle cover frictionally and selectively mountable to said keg nozzle of the keg tap.

2. The keg tap sanitation cover device of claim 1, wherein said nozzle cover is an elastic nozzle cover.

3. The keg tap sanitation cover device of claim 1, wherein said nozzle cover is a flexible molded nozzle cover.

4. The keg tap sanitation cover device of claim 1, wherein said keg nozzle is a beer keg nozzle.

5. The keg tap sanitation cover device of claim 1, wherein said nozzle cover having a length between said closed top end and said open bottom end, further wherein said length is from 2 inches to 6 inches.

6. The keg tap sanitation cover device of claim 1, wherein said nozzle cover having embedded antimicrobial agents.

7. The keg tap sanitation cover device of claim 3, wherein said flexible molded nozzle cover having a material of food-grade silicone.

8. The keg tap sanitation cover device of claim 3, wherein said flexible molded nozzle cover is selected from a material consisting of a plastic and a rubber.

9. The keg tap sanitation cover device of claim 1, wherein said exterior surface of said nozzle cover is textured for an improved grip of said nozzle cover.

10. The keg tap sanitation cover device of claim 1, wherein said loop is an eyelet having a circular aperture.

11. The keg tap sanitation cover device of claim 10, wherein said eyelet having a material selected from the group consisting of a stainless steel and a brass.

12. The keg tap sanitation cover device of claim 11, wherein said tether having a material selected from the group consisting of a metal and a plastic.

13. The keg tap sanitation cover device of claim 1, wherein said anchor is a plastic tie.

14. The keg tap sanitation cover device of claim 1, wherein said tether having a selectively adjustable length.

15. A keg tap sanitation cover device comprising:
a nozzle cover;
a loop;
a ring;
a tether; and
an anchor;
wherein said nozzle cover having a closed top end and an open bottom end;
wherein said nozzle cover having a cylindrical wall between said closed top end and said open bottom end;
wherein said cylindrical wall having an exterior surface forming a cavity within said cylindrical wall for accommodating a keg nozzle;
wherein said loop integrated to said closed top end of said nozzle cover;
wherein said ring connecting said loop to one end of said tether;
wherein said tether having said anchor at another end of said tether;
wherein said anchor connecting said nozzle cover to a faucet of the keg tap;
wherein said nozzle cover frictionally and selectively mountable to said keg nozzle of the keg tap; and
further wherein said closed top end having a UV-C light inside said nozzle cover.

16. A beer keg tap sanitation cover device comprising:
a nozzle cover;
a loop;
a ring;
a tether; and
an anchor;
wherein said nozzle cover having a closed top end and an open bottom end;
wherein said nozzle cover having a cylindrical wall between said closed top end and said open bottom end;
wherein said cylindrical wall having an exterior surface forming a cavity within said cylindrical wall for accommodating a beer keg nozzle;
wherein said loop integrated to said closed top end of said nozzle cover;
wherein said ring connecting said loop to one end of said tether;
wherein said tether having said anchor at another end of said tether;
wherein said anchor connecting said nozzle cover to a faucet of the beer keg tap;
wherein said nozzle cover frictionally and selectively mountable to said beer keg nozzle of the beer keg tap;
wherein said nozzle cover is a flexible molded nozzle cover; and
further wherein said flexible molded nozzle cover having a length from 2 inches to 6 inches between said closed top end and said open bottom end.

17. The beer keg tap sanitation cover device of claim 16, wherein said flexible molded nozzle cover having a material of food-grade silicone.

18. The beer keg tap sanitation cover device of claim 17, wherein said exterior surface of said flexible molded nozzle cover is textured for an improved grip of said flexible molded nozzle cover.

19. The beer keg tap sanitation cover device of claim 18, wherein said flexible molded nozzle cover having embedded antimicrobial agents.

20. The beer keg tap sanitation cover device of claim 19, wherein said tether having a selectively adjustable length.
